(19) United States
(12) Patent Application Publication
(10) Pub. No.: US 2016/0363664 A1
(43) Pub. Date: Dec. 15, 2016

(54) HIGH PRECISION SUBSURFACE IMAGING AND LOCATION MAPPING WITH TIME OF FLIGHT MEASUREMENT SYSTEMS

(71) Applicant: HUMATICS CORPORATION, Cambridge, MA (US)

(72) Inventors: David A. Mindell, Cambridge, MA (US); Gregory L. Charvat, Guilford, CT (US)

(21) Appl. No.: 15/181,978

(22) Filed: Jun. 14, 2016

Related U.S. Application Data
(60) Provisional application No. 62/175,819, filed on Jun. 15, 2015.
(60) Provisional application No. 62/198,633, filed on Jul. 29, 2015.
(60) Provisional application No. 62/243,264, filed on Oct. 19, 2015.
(60) Provisional application No. 62/253,983, filed on Nov. 11, 2015.
(60) Provisional application No. 62/268,727, filed on Dec. 17, 2015.
(60) Provisional application No. 62/268,734, filed on Dec. 17, 2015.
(60) Provisional application No. 62/268,736, filed on Dec. 17, 2015.
(60) Provisional application No. 62/268,741, filed on Dec. 17, 2015.
(60) Provisional application No. 62/268,745, filed on Dec. 17, 2015.
(60) Provisional application No. 62/271,136, filed on Dec. 22, 2015.
(60) Provisional application No. 62/275,400, filed on Jan. 6, 2016.
(60) Provisional application No. 62/306,469, filed on Mar. 10, 2016.
(60) Provisional application No. 62/306,478, filed on Mar. 10, 2016.
(60) Provisional application No. 62/306,483, filed on Mar. 10, 2016.

(51) Int. Cl. G01S 13/88; G01S 13/74; G01S 7/00; H04W 4/02; G01S 13/89

(52) U.S. Cl. CPC G01S 13/885; H04W 4/028; G01S 13/89; G01S 7/003; G01S 13/74

(57) ABSTRACT

A system for tracking a ground imaging apparatus includes a plurality of fixed devices and at least one tracked device. The fixed devices are positioned at fixed locations and the tracked device is affixable to the ground imaging apparatus. The fixed devices and the tracked device are configured to transmit and/or receive signals used for time of flight measurements. A processor is configured to determine one or more positions of the tracked device relative to one or more of the fixed devices based upon one or more time of flight measurements between the tracked device and one or more of the fixed devices.

### CROSS-REFERENCE TO RELATED APPLICATIONS

This application claims the benefit of co-pending U.S. provisional application Ser. No. 62/175,819 filed Jun. 15, 2015; 62/198,633 filed Jul. 29, 2015; 62/243,264 filed Oct. 19, 2015; 62/253,983 filed Nov. 11, 2015; 62/268,727, 62/268,734, 62/268,736, 62/268,741, and 62/268,745, each filed Dec. 17, 2015; 62/271,136 filed Dec. 22, 2015; 62/275,400 filed Jan. 6, 2016; and 62/306,469, 62/306,478, and 62/306,483, each filed Mar. 10, 2016, each of which is herein incorporated by reference in its entirety for all purposes.

### BACKGROUND

1. Field of the Disclosure

The present disclosure generally relates to position tracking systems, and more particularly to precise position tracking of subsurface imaging systems.

2. Discussion of Related Art

Ground or subsurface imaging systems, such as ground penetrating radar or seismology interrogation and equipment, provide data about underground features through generally non-invasive techniques. Images and models may be formed from the data collected by such systems. Conventional systems record or provide data about the location from which the data was collected, so that the underground features identified may be physically located underground. Such location information relies on imprecise location data and may contain inaccuracies of several feet or meters. Accordingly there exists a need to couple more precise location information about the position from which subsurface data has been collected in order to more precisely locate identified underground features.

### SUMMARY

Aspects and embodiments relate to position tracking systems, and more particularly to precise position tracking of subsurface imaging systems.

According to one aspect, a system for tracking a ground imaging apparatus includes a plurality of fixed devices configured to transmit and/or receive signals used for time of flight (TOF) measurements, the plurality of fixed devices positioned at a plurality of fixed locations; a first tracked device configured to transmit and/or receive signals used for TOF measurements, the first tracked device configured to be affixable to the ground imaging apparatus; and a processor configured to determine one or more positions of the tracked device relative to one or more of the plurality of fixed devices based upon one or more TOF measurements between the tracked device and one or more of the plurality of fixed devices.

In some embodiments the plurality of fixed devices comprises at least three fixed devices. In some embodiments the processor is configured to determine the one or more positions based upon absolute TOF distance measurements or based upon time difference of arrival (TDOA) measurements, or any combination thereof. In some embodiments the plurality of fixed devices are configured to be affixed to a portable structure. In some embodiments the processor is further configured to calibrate a position of one or more of the plurality of fixed devices relative to other of the plurality of fixed devices. In some embodiments one or more additional tracked devices are selectively affixable to the ground imaging apparatus, and the processor further configured to determine one or more positions of the one or more additional tracked devices. In some embodiments the processor is further configured to determine a plurality of positions of each tracked device over a series of distinct moments in time. In some embodiments the system includes a memory, the processor configured to store position and time information for one or more tracked devices in the memory. In some embodiments the processor is further configured to communicate position information for one or more tracked devices to a processor associated with the ground imaging apparatus. In some embodiments the processor is further configured to communicate position information for one or more tracked devices to a database. In some embodiments the processor is further configured to communicate position information for one or more tracked devices to a model of subsurface features. In some embodiments at least one of the signals is a frequency modulated continuous wave (FMCW) signal, a direct sequence spread spectrum (DSSS) signal, a pulse compressed signal, a frequency hopping spread spectrum (FHSS) signal, a Doppler modulated signal, an amplitude modulated signal, a phase modulated signal, a coded modulated signal or other modulated signal.

According to another aspect, a method for determining and tracking motion of a ground imaging apparatus includes mounting at least one transponder to the ground imaging apparatus to be tracked, the transponder having a receiver which receives an electromagnetic signal and a transmitter that emits an emitted electromagnetic signal; interrogating the at least one transponder by directing an interrogation electromagnetic signal at the transponder from at least three interrogators; emitting at least three emitted electromagnetic signals from the transponder in response to the interrogation signal from the three interrogators; and using the three emitted signals to determine a position of the transponder with respect to the at least three interrogators.

In some embodiments the at least three emitted electromagnetic signals are used to accomplish position measurements by multilateration. In some embodiments the at least three emitted electromagnetic signals are used to accomplish position measurements by a hyperbolic time difference of arrival methodology. In some embodiments each emitted electromagnetic signal is a modulated version of the interrogation signal. In some embodiments each emitted electromagnetic signal is a frequency shifted version of the interrogation signal. In some embodiments the transponder is configured to emit the emitted signal only if the transponder has received an auxiliary signal, the auxiliary signal indicating the transponder is selected to transmit. In some embodiments the transponder is configured to emit the emitted signal only if the transponder receives the electromagnetic signal having one of a command protocol and a unique code in the electromagnetic signal to address the transponder. In some embodiments the method includes transmitting signals between the at least three interrogators to measure a baseline between the interrogators for calibrating. In some embodiments the method includes mounting multiple transponders to the ground imaging apparatus to monitor motion of the ground imaging apparatus. In some embodiments the method includes determining a plurality of relative positions of the transponders at a plurality of times to monitor motion of the ground imaging apparatus over time. In some embodiments at least one transponder includes a sensor with the transponder configured to send a burst of data including data from the sensor for purposes of revealing characteristics of the ground imaging apparatus. In some embodiments the method includes superpositioning the data of the position of the ground imaging apparatus with the ground imaging data. In some embodiments the method includes forming a model or an image of a subsurface structure relative to the position data.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least on embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure.

### In the Figures:

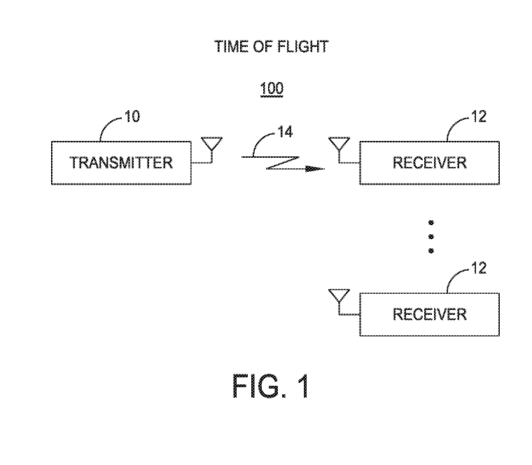

FIG. 1 illustrates one embodiment of a system for measuring distance with precision based on a bi-static ranging system configuration for measuring a direct time-of-flight (TOF);

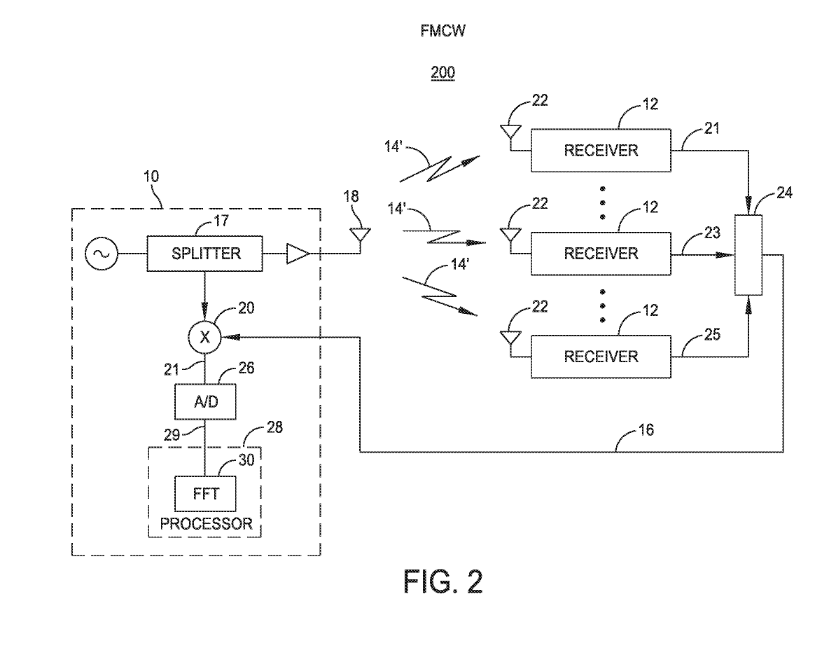

FIG. 2 illustrates one embodiment of a system for measuring distance with precision based on frequency modulated continuous wave (FMCW) TOF signals;

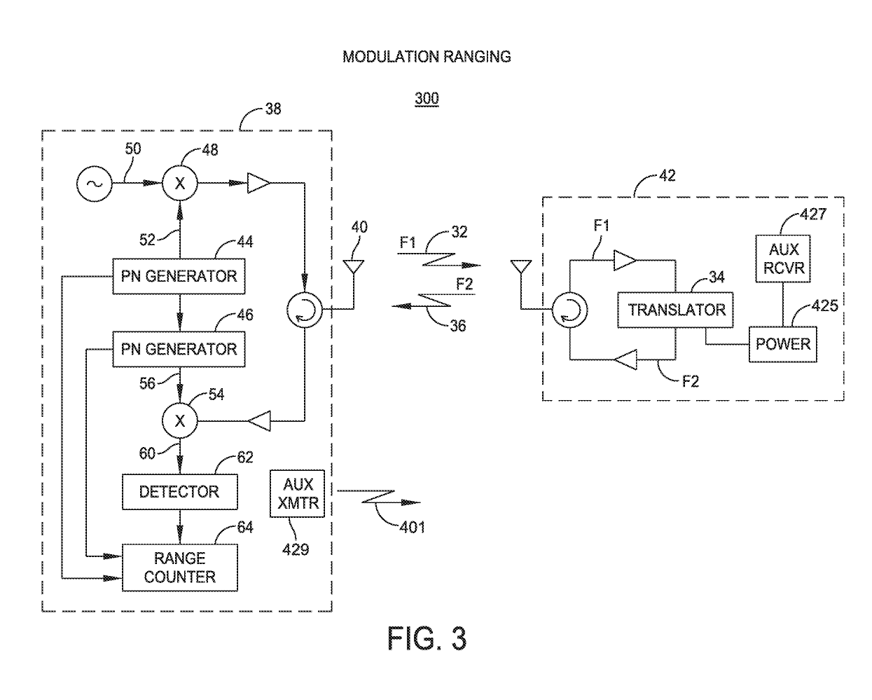

FIG. 3 illustrates one embodiment of a system for measuring distance with precision based on direct sequence spread spectrum (DSSS) TOF signals;

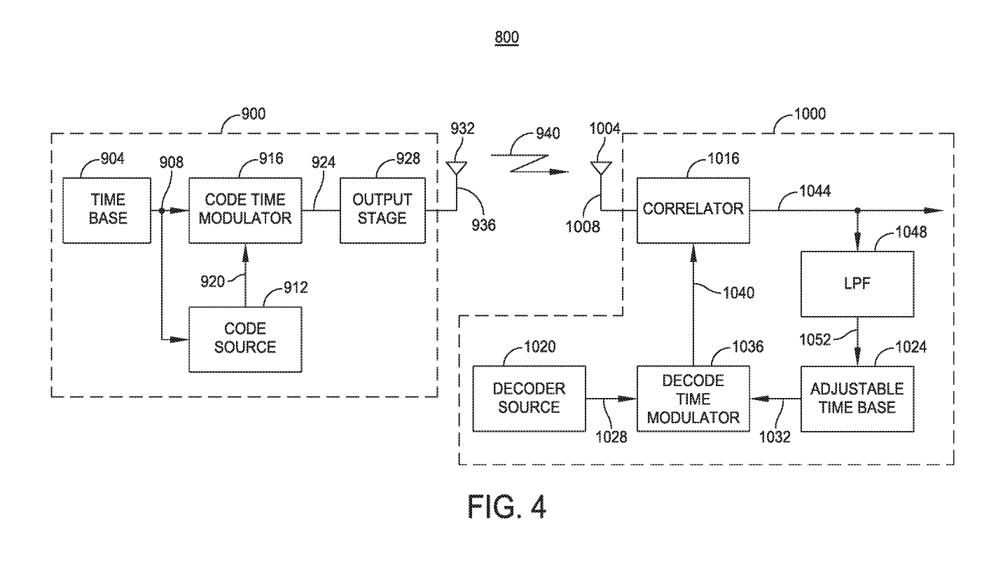

FIG. 4 illustrates one embodiment of a system for measuring distance with precision based on wide-band, ultra-wide-band pulsed signals, or any pulse compressed waveform;

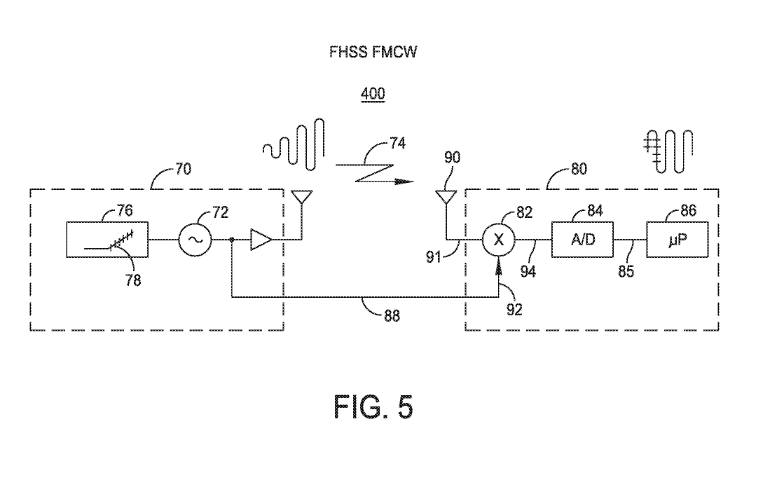

FIG. 5 illustrates one embodiment of a system for measuring distance with precision based on DSSS or frequency hopping spread spectrum (FHSS) FMCW ranging techniques;

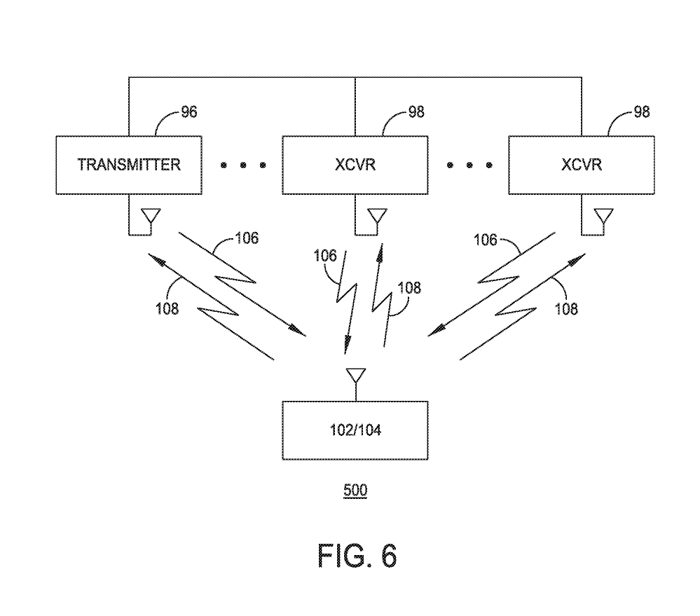

FIG. 6 illustrates one embodiment of a system for measuring distance with precision with TOF signals having multiple transmitters, multiple transceivers, or a hybrid combination of transmitter and transceivers;

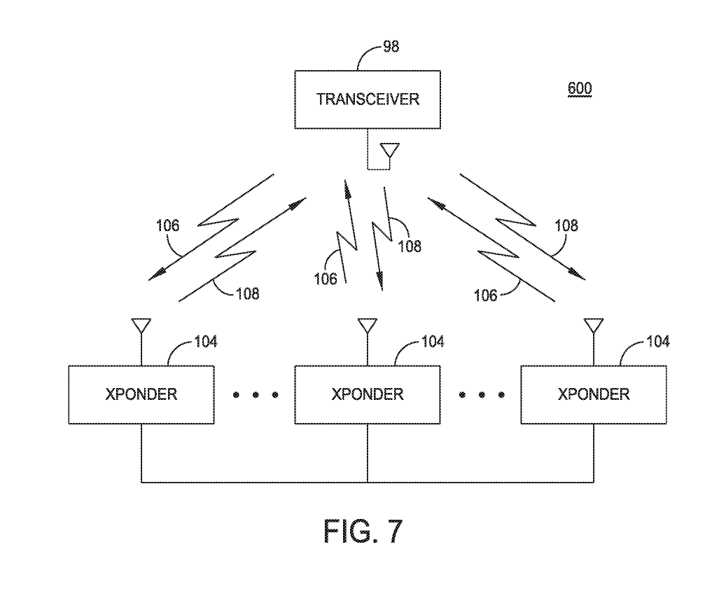

FIG. 7 illustrates one embodiment of a system for measuring distance with precision with TOF signals having multiple receivers, multiple transponders, or a hybrid combination of receivers and transponders;

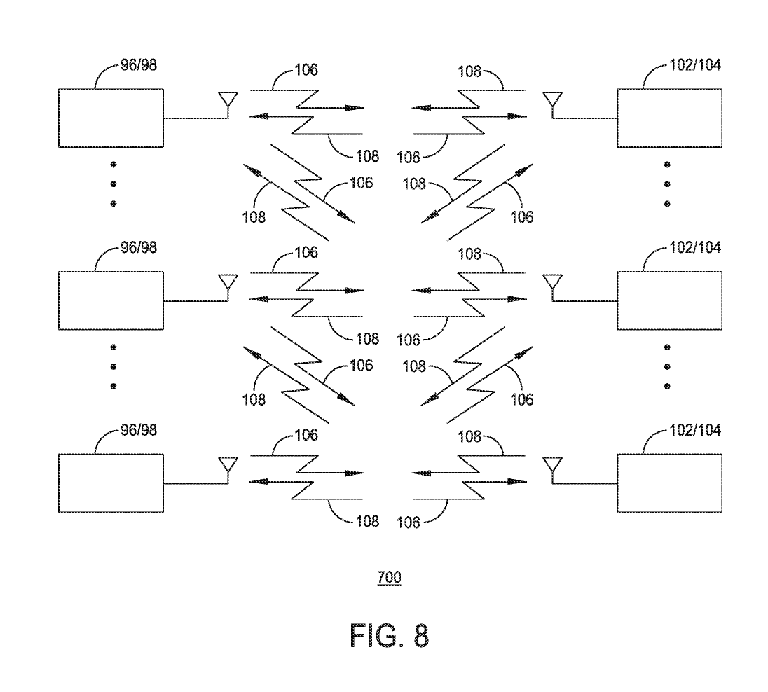

FIG. 8 illustrates one embodiment of a system for measuring distance with precision with TOF signals having multiple transmitters, multiple transceivers, or a hybrid combination of transmitter and transceivers and well as multiple receivers, multiple transponders, or a hybrid combination of receivers and transponders;

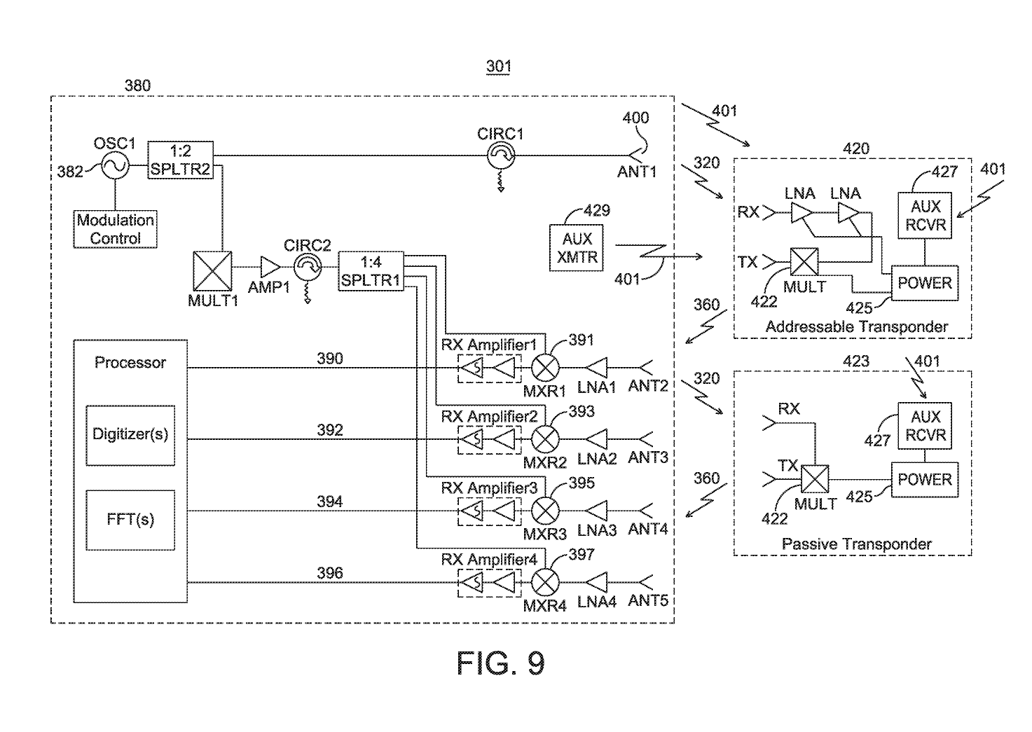

FIG. 9 illustrates one embodiment of a system for measuring location with precision with modulated TOF signals;

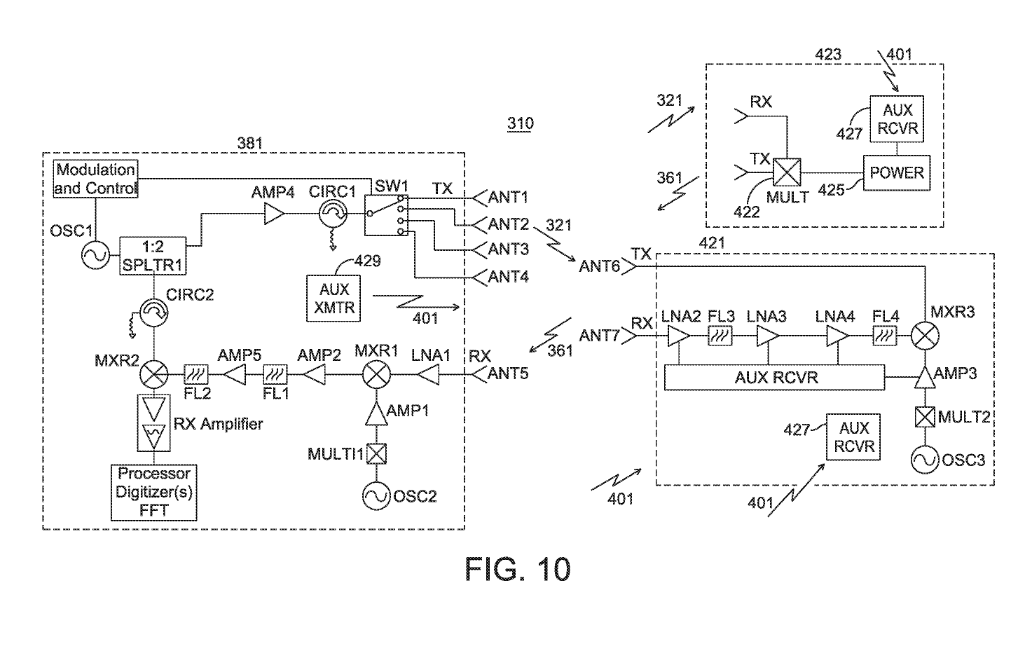

FIG. 10 illustrates another embodiment of a system for measuring location with precision with modulated TOF signals;

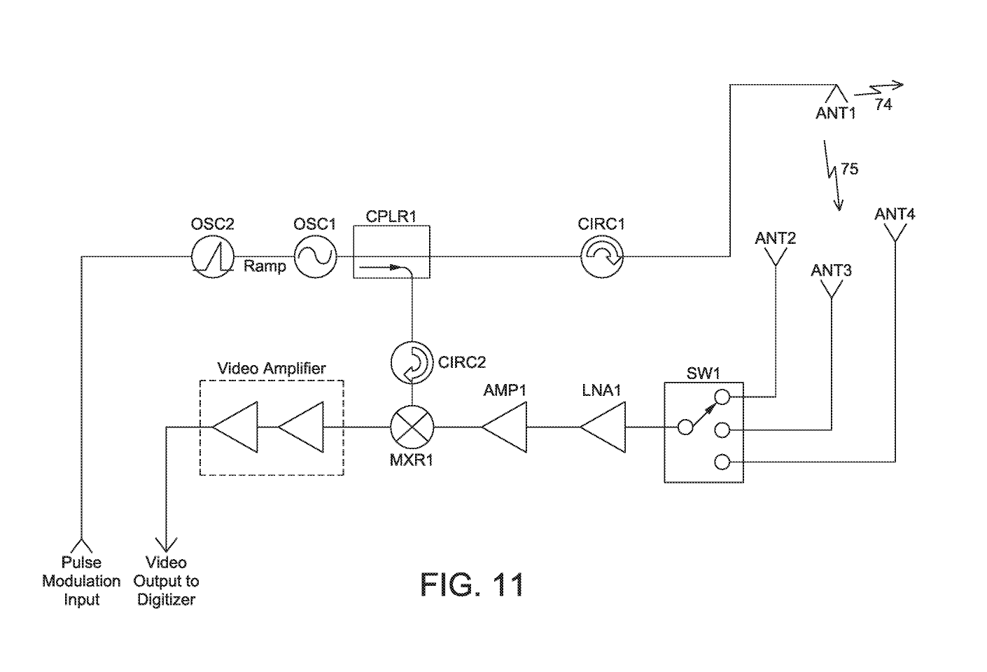

FIG. 11 illustrates a block diagram of an interrogator for linear FMCW two-way TOF ranging;

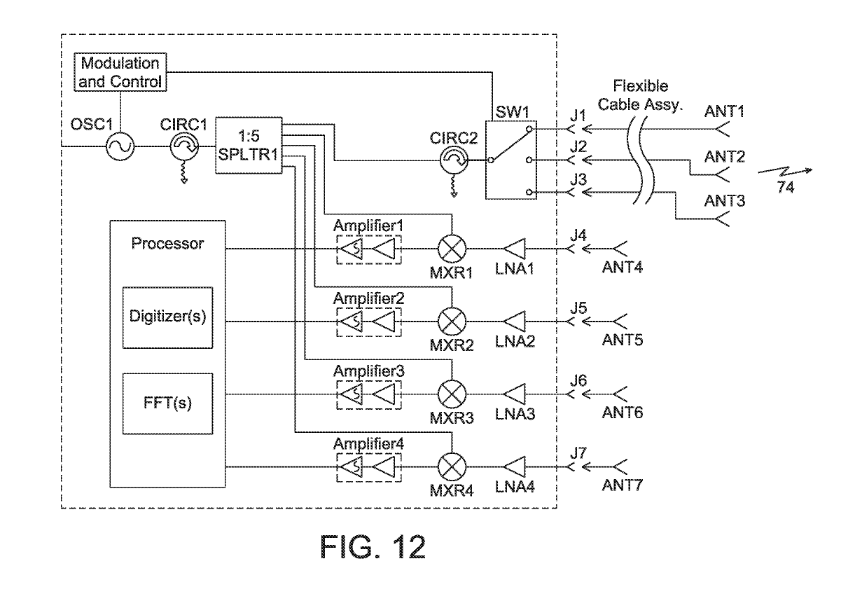

FIG. 12 illustrates another embodiment of a block diagram of an interrogator for linear FMCW two-way TOF ranging;

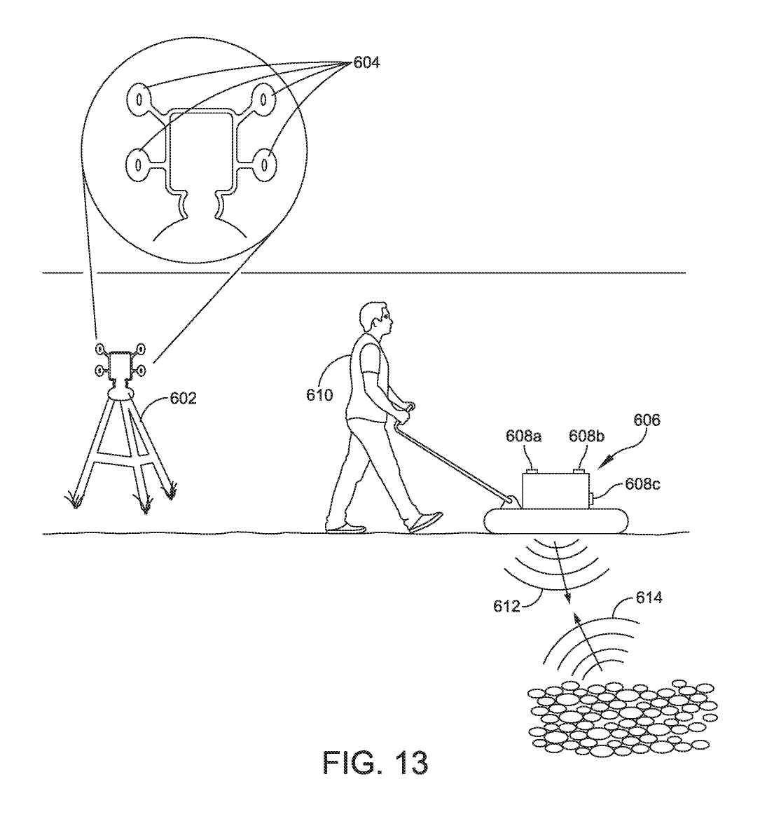

FIG. 13 illustrates one embodiment of a system for tracking the location of a ground penetrating radar; and

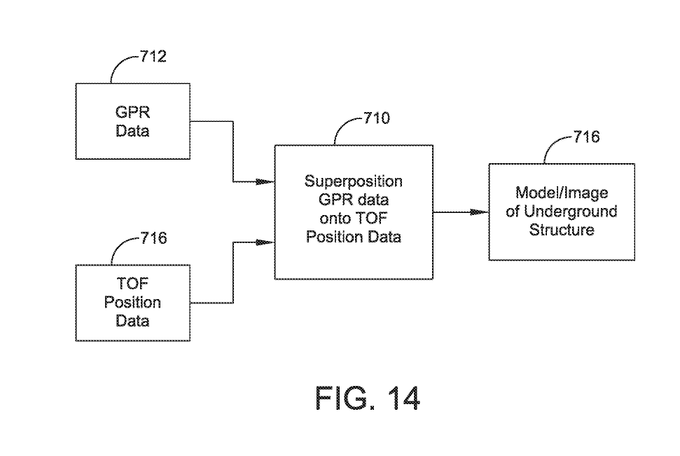

FIG. 14 is a schematic block diagram of a process for generating precisely located 3D models from ground penetrating radar.

### DETAILED DESCRIPTION

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

### DEFINITIONS

A transceiver is a device comprising both a trans fan electronic device that, with the aid of an antenna, produces electromagnetic signals) and a receiver (an electronic device that, with the aid of an antenna, receives electromagnetic signals and converts the information carried by them usable form) that share common circuitry.
A transmitter-receiver is a device comprising both a transmitter and a receiver combined but do not share common circuitry.
A transmitter is a transmit-only device, but may refer to transmit components a transmitter-receiver, a transceiver, or a transponder.
A receiver is a receive-only device, but may refer to receive components of a transmitter-receiver, a transceiver, or a transponder.
A transponder is a device that emits a signal in response to receiving an interrogating signal identifying the transponder and received from a transmitter.
Radar (for Radio Detection and Ranging) is an object-detection system that uses electromagnetic signals to determine the range, altitude, direction, or speed of objects. For purposes of this disclosure, “radar” refers to primary or “classical” radar, where a transmitter emits radiofrequency signals in a predetermined direction or directions, and a receiver listens for signals, or echoes, that are reflected back from an object.
Radio frequency signal “RF signal” refers to electromagnetic signals in the RF signal spectrum that can be CW or pulsed or any form.
Pulse Compression or pulse compressed signal refers to any coded, arbitrary, or otherwise time-varying waveform to be used for Time-of-Flight (TOF) measurements, including but not limited to FMCW, Linear FM, pulsed CW, Impulse, Barker codes, and any other coded waveform.
Wired refers to a network of transmitters, transceivers, receivers, transponders, or any combination thereof, that are connected by a physical waveguide such as a cable to a central processor.
Wireless refers to a network of transmitters, transceivers, receivers, transponders, or any combination thereof that are connected only by electromagnetic signals transmitted and received wirelessly, not by physical waveguide.
Calibrating the network refers to measuring distances between a transmitters, transceivers, receivers, transponders, or any combination thereof.
High precision ranging refers to the use electromagnetic signals to measure distances millimeter or sub-millimeter precision.
One-way travel tinge or TOF refers to the time it takes an electromagnetic signal to travel from a transmitter or transceiver to a receiver or transponder.
Two-way travel time or TOF refers to the time it takes an electromagnetic signal to travel from a transmitter or transceiver to a transponder plus the time it takes for the signal, or response, to return to the transceiver or a receiver.

Referring to FIG. 1, aspects and embodiments of one embodiment of a system for measuring distance with precision of the present invention are based on a hi-static ranging system configuration, which measures a direct time of flight (TOF) of a transmitted signal between at least one transmitter 10 and at least one receiver 12. This embodiment of a ranging system of the invention can be characterized as an apparatus for measuring TOF of an electromagnetic signal 14. This embodiment of an apparatus is comprised of at least one transmitter 10, which transmits an electromagnetic signal 14 to at least one receiver 12, which receives the transmitted signal 14 and determines a time of flight of the received signal. A time of flight of the electromagnetic signal 14 between the transmission time of the signal 14 transmitted from the transmitter 10 to the time the signal is received by the receiver 12 is measured to determine the TOF of the signal 14 between the transmitter and the receiver. A signal processor within one of the transmitter 10 and the receiver 12 analyzes the received and sampled signal to determine the TOF. The TOF of the signal 14 is indicative of the distance between the transmitter 10 and the receiver 12, and can be used for many purposes, some examples of which are described herein.

A preferred embodiment of the ranging system of the present invention is illustrated and described with reference to FIG. 2. In particular, one embodiment of a ranging system according to the present invention includes a transmitter 10 which can, for example, be mounted on an object for which a position and/or range is to be sensed. The transmitter 10 transmits a frequency modulated continuous wave (FMCW) signal 14′. At least one receiver 12 is coupled to the transmitter 10 by a cable 16. The cable 16 returns the received transmitted signal received by the at least one receiver back to the transmitter 10. In the transmitter 10, the transmitted signal 14′ is split by a splitter 17 prior to being fed to and transmitted by an antenna 18. A portion of the transmitted signal 14′ that has been split by the splitter 16 is fed to a first port of a mixer 20 and is used as local oscillator (LO) signal input signal for the mixer. The transmitted signal 14′ is received by an antenna 22 at the receiver 12 and is output by the at least one receiver 12 to a combiner 24, which combines the received signals from the at least one receiver 12 and forwards the combined received signals with the cable 16 to a second port of the mixer 20. An output signal 21 from the mixer has a beat frequency that corresponds to a time difference between the transmitted signal from the transmitter 10 to the received signal by the receiver 12. Thus, the beat frequency of the output signal 21 of the mixer is representative of the distance between the transmitter and the receiver. The output signal 21 of the mixer 20 is supplied to an input of an Analog to Digital converter 26 to provide a sampled output signal 29. The sampled signal 29 can be provided to a processor 28 configured to determine the beat frequency to indicate a TOF, which is indicative of the distance between the transmitter and receiver.

This embodiment of the ranging system is based on the transmission and reception of an FMCW transmitted signal and determining a beat frequency difference between the transmitted and received signals. The beat frequency signal is proportional to the TOF distance between the transmitter and the receiver. By way of example, the sampled signal from the A/D converter 26 is fed to the Fast Fourier Transform (FFT) device 30 to transform the sampled time signal into the frequency domain x(t) [symbol] X(k). It will be understood that other transforms or algorithms may be used, such as multiple signal classifiers (MUSIC), estimation of signal parameters via rotational invariance techniques (ESPRIT), discrete Fourier transforms (DFT), and inverse Fourier transforms (IFT), for example. From the FFT, the TOF of the signal 14′ can be determined. In particular, the data output from the A/D converter 26 is a filtered set of amplitudes, with some low frequency noise. According to aspects of this embodiment a minimum amplitude threshold for object detection to occur can be set so that detection is triggered by an amplitude above the minimum threshold. If an amplitude of the sampled signal at a given frequency does not reach the threshold, it may be ignored.

In the system illustrated in FIG. 2, any number of additional receivers 12 can be included in the system. The output signals from the additional receivers 12 are selected by a switch 24 and fed back to the transmitter 10 by the cable 16 to provide selected received signals at the additional receivers for additional time of flight measured signals at additional receivers 12. In an alternate embodiment, the mixer 20 and the A/D converter 26 can be included in each receiver to output a digital signal from each receiver. In this embodiment, the digital signal can be selected and fed back to the transmitter for further processing. It is appreciated that for this embodiment, the FFT processing can be done either in each receiver or at the transmitter. The TOF measured signals resulting from the additional receivers 12 can be processed to indicate the position of the object to which the transmitter 10 is mounted with a number of degrees of freedom and with excellent resolution according to the present invention. Also as is illustrated with reference to FIG. 8, according to aspects and embodiments of this disclosure, it is appreciated that multiple transmitters can be coupled to multiple receivers to produce a sophisticated position-detecting system.

In the ranging system of FIG. 2, at least one transmitter 10 can be mounted on an object to be tracked in distance and position. The receivers each generate a signal for determining a TOF measurement for the signal 14′ transmitted by the transmitter. The receivers 12 are coupled to the processor 28 to produce data indicating the TOF from the transmitter to each of the three receivers, which can be used for precise position detection of the transmitter 10 coupled to the object. It is appreciated that various arrangements of transmitters and receivers may be used to triangulate the position of the object to which the transmitter is attached, providing information such as x, y, z position as well as translation and 3 axes of rotation of the transmitter 10.

It is appreciated that for any of the embodiments and aspects disclosed herein, there can be coordinated timing between the transmitter and receivers to achieve the precise distance measurements. It is also appreciated that the disclosed embodiments of the system are capable of measuring distance by TOF on the order of about a millimeter or sub-millimeter scale in precision, at 1 Hz or less in frequency over a total range of hundreds of meters. It is anticipated that embodiments of the system can be implemented with very low-cost components for less $100.

### Modulation Ranging Systems.

Referring to FIG. 3, there is illustrated another embodiment of a ranging system 300 implemented according to the present invention. It is appreciated that various form of modulation such as harmonic modulation, Doppler modulation, amplitude modulation, phase modulation, frequency modulation, signal encoding, and combinations thereof can be used to provide precision navigation and localization. One such example is illustrated in FIG. 3, which illustrates a use of pulsed direct sequence spread spectrum (DSSS) signals 32 to determine range or distance. In direct sequence spread spectrum ranging systems, code modulation of the transmitted signal 32 and demodulation of a received and re-transmitted signal 36 can be done by phase shift modulating a carrier signal. A transmitter portion of a transceiver 38 transmits via an antenna 40 a pseudo-noise code-modulated signal 32 having a frequency F1. It is to be appreciated that in a duplex ranging system, the transceiver 38 and a transponder 42 can operate simultaneously.

As shown in FIG. 3, the transponder 42 receives the transmitted signal 32 having frequency F1, which is fed to and translated by a translator 34 to a different frequency F2, which can be for example 2×F1 and is retransmitted by the transponder 42 as code-modulated signal 36 having frequency F2. A receiver subsystem of the transceiver 38, which is co-located with the transmitter portion of the transceiver 38 receives the retransmitted signal 36 and synchronizes to the return signal. In particular, by measuring the time delay between the transmitted signal 32 being transmitted and received signal 36, the system can determine the range from itself to the transponder. In this embodiment, the time delay corresponds to the two-way propagation delay of the transmitted 32 and retransmitted signals 36.

According to aspects of this embodiment, the system can include two separate PN code generators 44, 46 for the transmitter and receiver subsystems of the transceiver 38, so that the code at the receiver portion of the transceiver can be out of phase with the transmitted code or so that the codes can be different.

The transmitter portion of the transceiver 38 for measuring TOF distance of an electromagnetic signal comprises a 1st pseudo noise generator 44 for generating a first phase shift signal, a first mixer 48 which receives a carrier signal 50, which modulates the carrier signal with a first phase shift signal 52 to provide a pseudo-noise code-modulated signal 32 having a center frequency F1 that is transmitted by the transceiver 38. The transponder apparatus 42 comprises the translator 34 which receives the pseudo-noise code-modulated signal 32 having center frequency F1 and translates the pseudo-noise code-modulated signal of frequency F1 to provide a translated pseudo-noise code-modulated signal having a center frequency F2 or that provides a different coded signal centered at the center frequency F1, and that is transmitted by the transponder back to the transceiver 38. The transceiver apparatus 38 further comprises a second pseudo noise generator 46 for generating a second phase shift signal 56, and a second mixer 54 which receives the second phase shift signal 56 from the pseudo-noise generator 46, which receives the translated pseudo-noise code-modulated signal 36 at frequency F2 and modulates the pseudo-correlated code-modulated signal 36 having center frequency F2 with the second phase shift signal 56 to provide a return signal 60. The apparatus further comprises a detector 62 which detects the return signal 60, and a ranging device/counter 64 that measures the time delay between the transmitted signal 32 and the received signal 36 to determine the round trip range from the transceiver 38 to the transponder 42 and back to the transceiver 38 so as to determine the two-way propagation delay. According to aspects of some embodiments, the first PN generator 44 and the second PN generator 46 can be two separate PN code generators.

It is appreciated that the preciseness of this embodiment of the system depends on the signal-to-noise ratio (SNR) of the signal, the bandwidth, and the sampling rate of the sampled signals. It is also appreciated that this embodiment of the system can use any pulse compressed signal.

FIG. 9 illustrates another embodiment of a modulation ranging system 301. This embodiment can be used to provide a transmitted signal at frequency F1 from interrogator 380, which is received and harmonically modulated by transponder 420 to provide a harmonic return signal 360 at F2, which can be for example 2×F1, that is transmitted by the transponder 420 back to the interrogator 380 to determine precise location of the transponder. With the harmonic ranging system, the doubling of the transmitted signal 320 by the transponder can be used to differentiate the retransmitted transponder signal from a signal reflected for example by scene clutter.

As illustrated by FIGS. 3 and 9-10 along with the discussion above, a transponder 42, 420, 421, 423 may translate a received frequency F1 to a response frequency F2 and the response frequency F2 may be harmonically related to F1. A simple harmonic transponder device capable of doing so may include a single diode used as a frequency doubler, or multiplier, coupled to one or more antennas. FIG. 9 illustrates a simple harmonic transponder 423 that includes a receive antenna RX, a multiplier 422 that can simply be a diode, an optional battery 425, and an optional auxiliary receiver 427. FIG. 3 shows a transponder 42 having a single antenna for both receiving and transmitting signals to and from the transponder 42, while FIG. 9 shows separate antennas (labelled RX,TX) for both receiving and transmitting signals to and from the transponders 420, 423. It is appreciated that embodiments of any transponder 42, 420, 421, and 423 as disclosed herein, may have may have one shared antenna, may have multiple antennas such as a TX and an RX antenna, and may include different antenna arrangements.

An embodiment of transponder 42, 420, 421, 423 can include a frequency multiplying element 422, such as but not limited to a diode, integrated into an antenna structure. For example, a diode may be placed upon and coupled to a conducting structure, such as a patch antenna or microstrip antenna structure, and placed in a configuration so as to match impedance of a received and/or transmitted signal so as to be capable of exciting antenna modes at each of the receive and response frequencies.

An embodiment of a passive harmonic transponder 423 includes a low power source such as a battery 425 (for example a watch battery), which can be used to reverse bias the diode multiplier 422 to normally be off, and the low power source can be turned off to turn the harmonic transponder to an on state (a wake up state) to multiply or otherwise harmonically shift a frequency of a received signal. The low power source can be used to reverse bias the multiplier 422 to turn on and off the transponder, for example in applications like those discussed herein. According to an embodiment of the transponder, the power source 425 can also be configured to forward bias the multiplexer (diode) 422 to increase the sensitivity and increase the range of the transponder to kilometer range up from for example, a 10-100 meter range. In still another embodiment, amplification (LNA, LNA2, LNA3, LNA4) either solely or in combination with forward biasing of the multiplier diode 422, may also or alternatively be used to increase sensitivity of the transponder. It is appreciated that in general, amplification may be employed with any transponder to increase the sensitivity of any of the embodiments of a transponder of any of the ranging systems as disclosed herein.

According to aspects and embodiments, the diode-based transponder 423 can be a passive transponder that is configured to use very little power and may be powered via button-type or watch battery, and/or may be powered by energy harvesting techniques. This embodiment of the transponder is configured to consume low amounts of energy with the transponder in the powered off mode most of the time, and occasionally being switched to a wake up state. It is appreciated that the reverse biasing of the diode and the switching on and off of the diode bias takes little power. This would allow passive embodiments of the transponder 423 to run off of watch batteries or other low power sources, or to even be battery-less by using power harvesting techniques, for example from the TOF electromagnetic signals, or from motion, such as a piezoelectric source, a solenoid, or an inertial generator, or from a light source, e.g., solar. With such an arrangement, the interrogator 38, 380, 381 can include an auxiliary wireless transmitter 429 and the transponder 42, 420, 421, and 423 can include an auxiliary wireless receiver 427 as discussed herein, particularly with respect to FIGS. 3, 9-10, that is used to address each transponder to tell each transponder when to wake up. The auxiliary signal transmitted by auxiliary wireless transmitter 429 and received by auxiliary wireless receiver 427 is used to address each transponder to tell each transponder when to turn on and turn off. One advantage of providing the interrogator with the auxiliary wireless transmitter 429 and each transponder with an auxiliary wireless signal receiver 427 is that it provides for the TOF signal channel to be unburdened by unwanted signal noise such as, for example, communication signals from transponders that are not being used. With that said, it is also appreciated that another embodiment of the TOF system could in fact use the TOF signal channel to send and receive radio/control messages to and from the transponders to tell transponders to turn on and off, etc. With such an arrangement, the auxiliary wireless receiver 427 is optional.

It is appreciated that embodiments of the passive harmonic transponder 423 do not require a battery source that needs to be changed every day/few days. The passive harmonic transponder 423 can either have a long-life battery or for shorter range applications may be wirelessly powered by the main channel signal or by an auxiliary channel signal for longer range (e.g. the interrogator and transponder can operate over the 3-10 GHz range, while power harvesting can occur using either or both of the main signal range and a lower frequency range such as, for example, 900 MHz or 13 MHz. In contrast, classic harmonic radar tags simply respond as a chopper to an incoming signal, such that useful tag output power levels require very strong incoming signals such as >−30 dBm at the tag from a transmitter. It is appreciated that the passive harmonic transponder 423 provides a compact, long/unlimited lifetime long-range transponder by storing energy to bias the diode, drastically increasing the diode sensitivity and range of the transponder to, for example, 1 km scales.

One aspect of the embodiment shown in FIG. 9 of a modulation ranging system, or any of the embodiments of a ranging system as disclosed herein, is that each transponder 420 can be configured with an auxiliary wireless receiver 427 to be uniquely addressable by an auxiliary wireless signal 401 from the auxiliary wireless transmitter 429, such as for example a blue tooth signal, a Wi-Fi signal, a cellular signal, a Zigbee signal and the like, which can be transmitted by the interrogator 380. Thus, the interrogator 380 can be configured with an auxiliary wireless transmitter 429 to transmit an auxiliary wireless signal 401 to identify and turn on a particular transponder 420. For example, the auxiliary wireless signal 401 could be configured to turn on each transponder based on each transponder's serial number. With this arrangement, each transponder could be uniquely addressed by an auxiliary wireless signal provided by the interrogator. Alternately, an auxiliary signal to address and enable individual or groups of transponders may be an embedded control message in the transmitted interrogation signal, which may take the form of command protocols or unique codes. In other embodiments the auxiliary signal to enable a transponder may take various other forms.

As shown in FIG. 9, a transmitter portion of an interrogator 380 transmits via an antenna 400 a signal 320 having a frequency F1. The transponder can be prompted to wake up by auxiliary wireless transmitter 429 transmitting an auxiliary wireless signal and the transponder receiving with an auxiliary wireless receiver 427 the auxiliary wireless signal 401, such that the transponder 420 receives the transmitted signal 320 having frequency F1, which is doubled in frequency by the transponder to frequency F2 (=2×F1) and is retransmitted by the transponder 420 as signal 360 having frequency F2. A receiver subsystem of the interrogator 380, which is co-located with the transmitter portion of the interrogator 380 receives the retransmitted signal 360 and synchronizes the return signal to measure the precise distance and location between the interrogator 380 and the transponder 420. In particular, by measuring the time delay between the transmitted signal 320 being transmitted and the received signal 360, the system can determine the range from the interrogator to the transponder. In this embodiment, the time delay corresponds to the two-way propagation delay of the transmitted 320 and retransmitted signals 360.

For example, the transmitter portion of the interrogator 380 for measuring precise location of a transponder 420 comprises an oscillator 382 that provides a first signal 320 having a center frequency F1 that is transmitted by the interrogator 380. The transponder apparatus 420 comprises a frequency harmonic translator 422 which receives the first signal 320 having center frequency F1 and translates the signal of frequency F1 to provide a harmonic of the signal F1 having a center frequency F2, for example 2×F1 that is transmitted by the transponder 420 back to the interrogator 380. The interrogator 380 as shown further comprises four receive channels 390, 392, 394, 396 for receiving the signal F2. Each receive channel comprises a mixer 391, 393, 395, 397 which receives the second signal 360 at frequency F2 and down converts the return signal 360. The interrogator apparatus further comprises a detector which detects the return signal, an analog-to-digital converter and a processor to determine a precise measurement of the time delay between the transmitted signal 320 and the received signal 360 to determine the round trip range from the interrogator 380 to the transponder 420 and back to the interrogator 380 so as to determine the two-way propagation delay.

According to aspects of this embodiment, the interrogator can include four separate receive channels 390, 392, 394, 396 to receive the harmonic return frequencies of the retransmitted signal 401 in a spatially diverse array for the purpose of navigation. It is appreciated that the first signal 320 having a center frequency F1 can be varied in frequency according to any of the modulation schemes that have been discussed herein, such as, for example FMCW, and that the modulation could also be any of CW pulsed, pulsed, impulse, or any other waveform. It is to be appreciated that any number of channels can be used. It is also to be appreciated that in the four receive channels of the interrogator can either be multiplexed to receive the signal 360 at different times or can be configured to operate simultaneously. It is further appreciated that, at least in part because modulation is being used, the interrogator 380 and the transponder 420 can be configured to operate simultaneously.

It is to be appreciated that according to aspects and embodiments disclosed herein, the modulator can use different forms of modulation. For example, as noted above direct sequence spread spectrum (DSSS) modulation can be used. In addition, other forms of modulation such as Doppler modulation, amplitude modulation, phase modulation, coded modulation such as CDMA, or other known forms of modulation can be used either in combination with a frequency or harmonic translation or instead of a harmonic or frequency translation. In particular, the interrogator signal 320 and the transponder signal 360 can either be at the same frequency, i.e. F1, and a modulation of the interrogator signal by the transponder 420 can be done to provide the signal 360 at the same frequency F1, or the interrogator can also frequency translate the signal 320 to provide the signal 360 at a second frequency F2, which may be at a harmonic of F1, in addition to modulate the signal F1, or the interrogator can only frequency translate the signal 320 to provide the signal 360. As noted above, any of the noted modulation techniques provide the advantage of distinguishing the transponder signal 360 from background clutter reflected signal 320. It is to be appreciated that with some forms of modulation, the transponders can be uniquely identified by the modulation, such as coded modulation, to respond to the interrogation signal so that multiple transponders 420 can be operated simultaneously. In addition, as been noted herein, by using a coded waveform, there need not be a translation of frequency of the retransmitted signal 360, which has the advantage of providing a less expensive solution since no frequency translation is necessary.

It is to be appreciated that according to aspects and embodiments of any of the ranging system as disclosed herein, multiple channels may be used by various of the interrogator and transponder devices, for example, multiple frequency channels, quadrature phase channels, or code channels may be incorporated in either or both of interrogation or response signals. In other embodiments, additional channel schemes may be used. For example, one embodiment of a transponder 42, 420, 421, 423 can have both in phase and 90° out of phase (quadrature) channels with two different diodes where the diodes are modulated in quadrature by reverse biasing of the diodes. With such an arrangement, the interrogator could be configured to send coded waveform signals to different transponders simultaneously. In addition, other methods as discussed herein, such as polarization diversity, time sharing, a code-multiplexed scheme where each transponder has a unique pseudo-random code to make each transponder uniquely addressable, and the like provide for allow increased numbers of transponders to be continuously monitored at full energy sensitivity.

FIG. 10 illustrates another embodiment of a modulation ranging system 310. This embodiment can be used to provide a transmitted signal at frequency F1 from interrogator 381, which is received by transponder 421 and frequency translated by transponder 421 to provide a frequency shifted return signal 361 at F2, which can be arbitrarily related in frequency to F1 of the interrogator signal (it doesn't have to be a harmonic signal), that is transmitted by the transponder 421 back to the interrogator 381 to determine precise location of the transponder 421. With this arrangement illustrated in FIG. 10, for example the signal 321 at F1 can be at the 5.8 GHz Industrial Scientific and Medical band, and the return signal 361 at F2 can be in the 24 GHz ISM band. It is to be appreciated also that with this arrangement of a modulation system, the frequency shifting of the transmitted signal 321 by the transponder 421 can be used to differentiate the retransmitted transponder signal 361 from a signal reflected for example by background clutter.

One aspect of this embodiment 310 of a modulation ranging system or any of the embodiments of a ranging system as disclosed herein is that each transponder 42, 420, 421, 423 can be configured to be uniquely addressable to wake up each transponder by receiving with an auxiliary wireless receiver 427 an auxiliary wireless signal 401 from an auxiliary wireless transmitter 429, such as for example a blue tooth signal, a Wi-Fi signal, a cellular signal, a Zigbee signal, and the like, which auxiliary wireless signal can be transmitted by the interrogator 381. Thus, the interrogator 381 can be configured with an auxiliary signal transmitter 429 to transmit an auxiliary wireless signal 401 to identify and turn on a particular transponder 42, 420, 421, 423. For example, the auxiliary wireless signal could be configured to turn on each transponder based on each transponder's serial number. With this arrangement, each transponder could be uniquely addressed by an auxiliary wireless signal provided by the interrogator or another source.

With respect to FIG. 10, it is appreciated that an oscillator such as OSC3 will have finite frequency error that manifests itself as finite estimated position error. One possible mitigation with a low cost TCXO (temperature controlled crystal oscillator) used for OSC3 is to have a user periodically touch their transponder to a calibration target. This calibration target is equipped with magnetic, optical, radar, or other suitable close range high precision sensors to effectively null out the position error caused by any long-term or short-term drift of the TCXO or other suitable low cost high stability oscillator. The nulling out is retained in the radar and/or transponder as a set of calibration constants that may persist for minutes, hours, or days depending on the users position accuracy needs.

According to aspects and embodiments the interrogator and each transponder of the system can be configured to use a single antenna (same antenna) to both transmit and receive a signal. For example, the interrogator 38, 380, 381 can be configured with one antenna 40, 400, to transmit the interrogator signal 32, 320, 321 and receive the response signal 36, 360, 361. Similarly, the transponder can be configured with one antenna to receive the interrogator signal 32, 320, 321 and transmit the response signal 36, 360, 361. This can be accomplished, for example, if coded waveforms are used for the signals. Alternatively, where the signals are frequency translated but are close in frequency, such as for example 4.9 GHz and 5.8 GHz, the same antenna can be used. Alternatively or in addition, it may be possible to provide the interrogator signal 32, 320, 321 at a first polarization, such as Left Hand Circular Polarization (LHCP), Right Hand Circular Polarization (RHCP), vertical polarization, horizontal polarization, and to provide the interrogator signal 36, 360, 361 at a second polarization. It is appreciated that providing the signals with different polarizations can also enable a system with the interrogator and the transponder each using a single antenna, thereby reducing costs. It is further appreciated that using circular polarization techniques mitigates the reflections from background clutter thereby reducing the effects of multi-path return signals, because when using circular polarization, the reflected signal is flipped in polarization, and so the multipath return signals could be attenuated by using linear polarizations and/or polarization filters.

According to aspects and embodiments of any of the systems disclosed herein, it is further appreciated that there can be selective pinging of each transponder 42, 420, 421, 423 to wake up each transponder by receiving with an auxiliary wireless receiver 427 an auxiliary wireless signal 401, such as for example a blue tooth signal, a Wi-Fi signal, a cellular signal, a Zigbee signal and the like, which can be transmitted by the interrogator 380 to provide for scene data compression. In particular, there can be some latency when using an auxiliary wireless signal to identify and interrogate each transponder 42, 420, 421, 423. As the number of transponders increases, this can result in slowing down of interrogation of all the transponders. However, some transponders may not need to be interrogated as often as other transponders. For example, in an environment where some transponders may be moving and others may be stationary, the stationary transponders need not be interrogated as often as the transponders that are actively moving. Still others may not be moving as fast as other transponders. Thus, by dynamically assessing and pinging more frequently the transponders that are moving or that are moving faster than other transponders, there can be a compression of the transponder signals, which can be analogized for example to MPEG4 compression where only pixels that are changing are sampled.

According to aspects and embodiments disclosed herein, the interrogators and transponders can be configured with their own proprietary micro-location frequency allocation protocol so that the transponders and interrogators can operate at unused frequency bands that exist amongst existing allocated frequency bands. In addition, the interrogators and transponders can be configured so as to inform users of legacy systems at other frequencies for situational awareness, e.g. to use existing frequency allocations in situations that warrant using existing frequency band allocations. Some advantages of these aspects and embodiments are that it enables a control for all modes of travel (foot, car, aerial, boat, etc.) over existing wired and wireless backhaul networks, with the interrogators and the transponders inter-operating with existing smart vehicle and smart phone technologies such as Dedicated Short Range Communications (DSRC) and Bluetooth Low Energy (BLE) radio.

In particular, aspects and embodiments are directed to high power interrogators in license-free bands e.g. 5.8 GHz under U-NII and frequency sharing schemes via dynamic frequency selection and intra-pulse sharing wherein the system detects other loading issues such as system timing and load factor, and the system allocates pulses in between shared system usage. One example of such an arrangement is dynamic intra pulse spectrum notching on the fly. Another aspect of embodiments disclosed herein is dynamic allocation of response frequencies by a lower power transponder at license-free frequency bands (lower power enables wider selection of transponder response frequencies).

Another aspect of embodiments of interrogators and transponders disclosed herein is an area that has been configured with a plurality of interrogators (a localization enabled area) can have each of the transponders enabled with BLE signal emitting beacons (no connection needed), as has been noted herein. With this arrangement, when a user having a transponder, such as a wearable transponder, enters into the localization area, the transponder “wakes up” to listen for the BLE interrogation signal and replies as needed. It is also appreciated that the transponder can be configured to request an update on what's going on, either over the BLE channel or another frequency channel, such as a dynamically allocated channel.

Some examples of applications where this system arrangement can be used are for example as a human or robot walks, drives, or pilots a vehicle or unmanned vehicle through any of for example a dense urban area, a wooded area, or a deep valley area where direct line of sight is problematic and multipath reflections cause GNSS navigation solutions to be highly inaccurate or fail to converge altogether. The human or robot or vehicle or unmanned vehicle can be equipped with such configured with transponders and interrogators can be configured to update the transponders with their current state vector as well as broadcast awareness of their state vector over preselected or dynamically selected frequency using wireless protocols, Bluetooth Low Energy, DSRC, and other appropriate mechanisms for legal traceability (accident insurance claims, legal compliance).

One implementation can be for example with UDP multicasting, wherein the transponders are configured to communicate all known state vectors of target transponders with UDP multicast signals. The UDP multicast encrypted signals can be also be configured to be cybersecurity protected against spoofing, denial of service and the like. One practical realization of the network infrastructure may include: Amazon AWS IoT service, 512 byte packet increments, TCP Port 443, MQTT protocol, designed to be tolerant of intermittent links, late to arrive units, and brokers and logs data for traceability, and machine learning.

### Wide-Band or Ultra-Wide-Band Ranging Systems.

FIG. 4 illustrates an embodiment of a wide-band or ultra-wide-band impulse ranging system 800. The system includes an impulse radio transmitter 900. The transmitter 900 comprises a time base 904 that generates a periodic timing signal 908. The time base 904 comprises a voltage controlled oscillator, or the like, which is typically locked to a crystal reference, having a high timing accuracy. The periodic timing signal 908 is supplied to a code source 912 and a code time modulator 916.

The code source 912 comprises a storage device such as a random access memory (RAM), read only memory (ROM), or the like, for storing codes and outputting the codes as code signal 920. For example, orthogonal PN codes are stored in the code source 912. The code source 912 monitors the periodic timing signal 908 to permit the code signal to be synchronized to the code time modulator 916. The code time modulator 916 uses the code signal 920 to modulate the periodic timing signal 908 for channelization and smoothing of the final emitted signal. The output of the code time modulator 916 is a coded timing signal 924.

The coded timing signal 924 is provided to an output stage 928 that uses the coded timing signal as a trigger to generate electromagnetic pulses. The electromagnetic pulses are sent to a transmit antenna 932 via a transmission line 936. The electromagnetic pulses are converted into propagating electromagnetic waves 940 by the transmit antenna 932. The electromagnetic waves propagate to an impulse radio receiver through a propagation medium, such as air.

FIG. 4 further illustrates an impulse radio receiver 1000. The impulse radio receiver 1000 comprises a receive antenna 1004 for receiving a propagating electromagnetic wave 940 and converting it to an electrical received signal 1008. The received signal is provided to a correlator 1016 via a transmission line coupled to the receive antenna 1004.

The receiver 1000 comprises a decode source 1020 and an adjustable time base 1024. The decode source 1020 generates a decode signal 1028 corresponding to the code used by the associated transmitter 900 that transmitted the signal 940. The adjustable time base 1024 generates a periodic timing signal 1032 that comprises a train of template signal pulses having waveforms substantially equivalent to each pulse of the received signal 1008.

The decode signal 1028 and the periodic timing signal 1032 are received by the decode timing modulator 1036. The decode timing modulator 1036 uses the decode signal 1028 to position in time the periodic timing signal 1032 to generate a decode control signal 1040. The decode control signal 1040 is thus matched in time to the known code of the transmitter 900 so that the received signal 1008 can be detected in the correlator 1016.

An output 1044 of the correlator 1016 results from the multiplication of the input pulse 1008 and the signal 1040 and integration of the resulting signal. This is the correlation process. The signal 1044 is filtered by a low pass filter 1048 and a signal 1052 is generated at the output of the low pass filter 1048. The signal 1052 is used to control the adjustable time base 1024 to lock onto the received signal. The signal 1052 corresponds to the average value of the correlator output, and is the lock loop error signal that is used to control the adjustable time base 1024 to maintain a stable lock on the signal. If the received pulse train is slightly early, the output of the low pass filter 1048 will be slightly high and generate a time base correction to shift the adjustable time base slightly earlier to match the incoming pulse train. In this way, the receiver is held in stable relationship with the incoming pulse train.

It is appreciated that this embodiment of the system can use any pulse compressed signal. It is also appreciated that the transmitter 900 and the receiver 1000 can be incorporated into a single transceiver device. First and second transceiver devices according to this embodiment can be used to determine the distance d to and the position of an object. Further reference to functionalities of both a transmitter and a receiver are disclosed in U.S. Pat. No. 6,297,773 System and Method for Position Determination by Impulse Radio, which is herein incorporated by reference.

### Linear FM and FHSS FMCW Ranging Systems.

Referring to FIG. 5, there is illustrated another embodiment of a ranging system 400 implemented according to the present invention that can use either linear FMCW ranging or frequency hopping spread spectrum (FHSS) FMCW ranging signals and techniques.

According to one embodiment implementing linear FMCW ranging, a transmitted signal 74 is swept through a linear range of frequencies and transmitted as transmitted signal 74. For one way linear TOF FMCW ranging, at a separate receiver 80, a linear decoding of the received signal 74 and a split version of the linear swept transmitted signal are mixed together at a mixer 82 to provide a coherent received signal corresponding to the TOF of the transmitted signal. Because this is done at a separate receiver 80, it yields a one-way TOF ranging.

FIG. 11 illustrates a block diagram of an embodiment of an interrogator for linear FMCW two-way TOF ranging. In the Embodiment of FIG. 11, an interrogator transmits via antenna 1 (ANT1) a linear FM modulated chirp signal 74 (or FMCW) towards a transponder (not illustrated) as shown for example in FIG. 5. The transponder can for example frequency shift the linear FM modulated chirp signal 74 and re-transmit a frequency shifted signal 75 at different frequency as discussed herein for aspects of various embodiments of a transponder. For example, as discussed herein, a transponder tag is tracked by receiving, amplifying, then frequency mixing the linear FM modulated interrogation signal and re-transmitting it out at a different frequency. This allows the tag to be easily discernable from clutter, or in other words, so it can be detected among other radar reflecting surfaces. The frequency offset return signal 75 and any scattered return signal 74 are collected by receiver antenna 2 (ANT2), antenna 3 (ANT3) and antenna 4 (ANT4), amplified by a low noise amplifier LNA1 and an Amplifier AMP1, and multiplied by the original chirp signal supplied via the circulator CIRC2 in the mixer MXR1. In the illustrated embodiment the antennas are multiplexed by a single-pole multi-throw switch SW1. The product is amplified via a video amplifier fed out to a digitizer where ranging information can be computed. It is appreciated that although linear FM is discussed in this example any arbitrary waveform can be used including but not limited to impulse, barker codes, or any pulse or phase coded waveforms of any kind. The interrogator and the transponder can work with any arbitrary waveforms including but not limited to linear FM (or FMCW), impulse, pulsed CW, barker codes, or any other modulation techniques that fits within the bandwidth of its signal chain.

FIG. 12 illustrates another embodiment of a block diagram of an interrogator for linear FMCW two-way TOF ranging. This embodiment differs from the embodiment of FIG. 11, primarily in that the interrogator has three transmit antennas to allow for three dimensional ranging of the interrogator and four receive channels for receiving the re-transmitted signal. This embodiment was prototyped and tested. The transmitted signal was transmitted with a Linear FM modulation, 10 mS chirp over a 4 GHz bandwidth from 8.5 GHz to 12.5 GHz. The transmitted output power was +14 dBm. With this arrangement, precision localization was measured and achieved to an accuracy of 27 um in Channel 0, 45 um in Channel 1, 32 um in Channel 2 and 59 um in Channel 3.

With FHSS FMCW ranging, the transmitted signal is not linearly swept through a linear range of frequencies as is done with linear FMCW ranging, instead the transmitted signal is frequency modulated with a series of individual frequencies that are varied and transmitted sequentially in some pseudo-random order according to a specific PN code. It might also exclude particular frequency bands, for example, for purposes of regulatory compliance. For FHSS FMCW ranging at a separate receiver 80 for one way TOF ranging, a decoding of the received signal 74 and a split version of the individual frequencies that are varied and transmitted sequentially according to a specific PN code are mixed together at a mixer 82 to provide a coherent received signal corresponding to the TOF of the transmitted signal. For FHSS FMCW, this is done at a separate receiver 80 for one-way TOF ranging.

More specifically, this embodiment of an apparatus 400 for measuring TOF distance via a linear FHSS FMCW electromagnetic signal comprises a transmitter 70 comprising a local oscillator 72 for generating a signal 74 and a linear ramp generator 76 coupled to the local oscillator that sweeps the local oscillator signal to provide a linear modulated transmitted signal 74 for linear modulation. According to the FHSS FMCW embodiment, instead of a linear ramp generator, the signal provided to modulate the local oscillator signal is broken up into discrete frequency signals 78 that modulate the local oscillator signal to provide a series of individual frequencies according to a specific PN code for modulating the local oscillator signal. The modulated transmitted signal 74 modulated with the series of individual frequencies are transmitted sequentially in some pseudo-random order, according to a specific PN code, as the transmitted signal. For one-way TOF measurements, a split off version of the transmitted signal is also fed via a cable 88 to a receiver 80. The receiver 80 receives the transmitted signal at an antenna 90 and forwards the received signal to a first port 91 of the mixer. The mixer also receives the signal on cable 88 at a second port 92 and mixes the signal with the received signal 74, to provide at an output 94 of the mixer a signal corresponding to the time of flight distance between the transmitter 70 and the receiver 80 of the transmitted signal 74 that is either linear modulated (for linear FMCW) or modulated with the PN codes of individual frequencies (for FHSS FMCW). The apparatus further comprises an analog to digital converter 84 coupled to an output 94 of the mixer 82 that receives that signal output from the mixer and provides a sampled output signal 85. The sampled output signal 85 is fed to a processor 86 that performs a FFT on the sampled signal. According to aspects of this embodiment, the ranging apparatus further comprises a frequency generator configured to provide signals at a plurality of discrete frequencies and processor to provide a randomized sequence of the individual frequency signals.

It is appreciated that this embodiment of the system can use any pulse compressed signal.

It is desirable to make the interrogators and the transponders as have been discussed herein as small as possible and as cheap as possible, so that the interrogators and transponders can be used anywhere and for anything. This it is desirable to implement as much of the interrogator structure and functionality and as much of the transponder structure and functionality as can be done on a chip. It is appreciated that one of the most inexpensive forms of manufacturing electronic devices is as a CMOS implementation. Accordingly, aspects and embodiments of the interrogators and transponders as described herein are to be implemented as CMOS.

Multiple Transmitter and/or Transceivers

Referring to FIG. 6, it is to be appreciated that various embodiments of a ranging system 500 according to the invention can comprise multiple transmitters 96, multiple transceivers 98, or a combination of both transmitter and transceivers that transmit a transmitted signal 106 that can be any of the signals according to any of the embodiments described herein. Such embodiments include at least one receiver 102 that either receives the transmitted signal 106 from each transmitter and/or at least one transponder 104 that receives the transmitted signal and re-transmits a signal 108 that is a re-transmitted version of the transmitted signal 106 back to a plurality of transceivers 98, according to any of ranging signals and systems described herein.

One example of a system according to this embodiment includes one transceiver 98 (interrogator) that transmits a first interrogation signal 106 to at least one transponder 104, which transponder can be attached to an object being tracked. The at least one transponder retransmits a second re-transmitted signal 108 that is received by, for example second, third, and fourth transceivers 98 to determine a position and a range of the transponder and the object being tracked. For example two transceivers can be grouped in pairs to do hyperbolic positioning and three transceivers can be grouped to do triangulation position to the transponder/object. It is appreciated that any of the transceivers 98 can be varied to be the interrogator that sends the first transmit interrogation signal to the transponder 104 and that any of the transceivers 98 can be varied to receive the re-transmitted signal from the responder. It is appreciated that where ranging to the transponder is being determined at the transceivers, the range and position determination is a time of flight measurement between the signals transmitted by the transponder 104 and received by at least two of the transceivers 98.

Another example of a system according to this embodiment includes at least one transponder 104, which can be attached to an object being tracked. The at least one transponder 104 receives a signal 106 that is transmitted by any of at least first, second, third, and fourth transceivers 98 (interrogators). The signal can be coded to ping at least one of the transponders. It is appreciated that more than one transponder 104 can be provided. It is appreciated that each transponder can be coded to respond to a different ping of the transmitted signal 106. It is appreciated that multiple transponders can be coded to respond to a same ping of the transmitted signal 106. Thus, it is appreciated that one transponder or any of a plurality of transponders or a plurality of the transponders can be pinged by the signal 106 transmitted by at least one of the transceivers 98. It is appreciated that multiple transceivers can be configured to send a signal 106 having a same code/ping. It is also appreciated that each transceiver can be configured to send a transmitted signal having a different code/ping. It is further appreciated that pairs or more of transceivers can be configured to send a signal having the same code/ping. It is also appreciated that pairs or more of the transponders can be configured to respond to a signal having the same code/ping. It is appreciated that where the range to the transponder is being determined at the transponder (the device being tracked), the range determination is a time difference of arrival measurement between the signal transmitted by at least two of the transceivers 98. For example, where the transponder is pinged by two of the transceivers 98 a hyperbolic positioning of the transponder (object) can be determined. Where the transponder is pinged by three of the transceivers 98, triangulation positioning of the transponder (object) can be determined.

Alternatively, instead of coding each signal with a ping, it is appreciated that according to some embodiments a precise time delay can be introduced between signals transmitted by the transmitters and/or transceivers. Alternatively, a precise time delay can be introduced between signals re-transmitted by the at least one transponder in response to receipt of the transmitted signal. With this arrangement pairs of transceivers can be used to accomplish 3D or hyperbolic positioning or at least three transceivers can be used to perform triangular positioning according to any of the signals described herein.

Another example of a system according to this embodiment includes one transmitter 96 that is a reference transmitter that provides a waveform by which the receivers 102 and/or transponders 104 correlate against to measure a delta in time of the time difference of arrival (TDOA) signal relative to the reference transmitter 96. It is also appreciated that this embodiment of the system can use any pulse compressed signal.

Multiple Receivers and/or Transponders

Various embodiments of a system according to the invention can comprise at least one transmitter 96 or transceiver 98 that transmits a transmitted 106 signal and a plurality of receivers 102 or transponders 104 that receive the transmitted signal from each transmitter or transceiver, according to any of ranging systems and signals described herein. Such embodiments include at least one transmitter 96 or transceiver 98 that transmits the transmitted signal 106 and a plurality of receivers 102 or transponders 104 that either receive the transmitted signal 106 or receive and re-transmit a signal 108 that is a re-transmitted version of the transmitted signal 106 back to the at least one transceivers 98, according to any of ranging signals and systems described herein.

It is appreciated that according to aspects of this embodiment a transmitter 96 can be attached to an object being tracked and can transmit a first signal 106 to a plurality of receivers 102 to perform time of flight positioning and ranging from the transmitter to the receiver. For example, where two receivers receive the transmitted signal, hyperbolic positioning of the transmitter/object can be achieved. Alternatively or in addition, where at least three receivers receive the transmitted signal 106, triangulation positioning to the transmitter 96 and object can be achieved.

According to aspects of another embodiment, at least one transceiver 98 can be attached to an object being tracked and can transmit a first signal 106 to a plurality of transponders 104 to perform positioning and ranging from the transmitter to the receiver. For example, where two transponders receive and re-transmit the transmitted signal 106, hyperbolic positioning of the transmitter/object can be achieved. Alternatively or in addition, where at least three transponders 104 receive and re-transmit the transmitted signal 106, triangulation positioning to the transceiver 98 and object can be achieved.

It is appreciated that any of the transponders can be varied to respond to the interrogator 98 that sends the first transmit interrogation signal to the transponder 104. It is appreciated that the at least one transponder 104 receives a signal 106 that is transmitted by the transceivers 98 (interrogators). The signal can be coded to ping at least one of the transponders. It is appreciated that each transponder can be coded to respond to a different ping of the transmitted signal 106. It is appreciated that multiple transponders can be coded to respond to a same ping of the transmitted signal 106. It is appreciated that one transponder or any of a plurality of transponders or a plurality of the transponders can be pinged by the signal 106 transmitted by at least one transceivers 98. It is also appreciated that pairs or more of the transponders can be configured to respond to a signal having the same code/ping.

Alternatively, instead of coding each signal with a ping, it is appreciated that according to some embodiments a precise time delay can be introduced between signals re-transmitted by the transponders 104 in response to receipt of the transmitted signal. With this arrangement pairs of transponders can be used to accomplish hyperbolic positioning of the at least one transceiver or at least three transponders can be used to perform triangular positioning according to any of the signals described herein. It is also appreciated that this embodiment of the system can use any pulse compressed signal.

### Hybrid Ranging Systems

Referring to FIG. 8, various embodiments of a system according to the invention can comprise a plurality of transmitters that transmit a transmitted signal and a plurality of receivers that receive a transmitted signal according to any of the signals and systems disclosed herein. Various embodiments of a system according to the invention can comprise a plurality of transceivers 98 that transmit a transmitted signal and a plurality of transponders 104 that receive the transmitted signal 106 and re-transmit the transmitted signal 108, according to any of ranging signals and ranging systems described herein. It is further appreciated that the plurality of the transmitters 96 or transceiver 98 can be coupled together either by a cable or a plurality of cables e.g. to create a wired mesh of transmitters or transceivers, or coupled together wirelessly to create a wireless mesh of transmitters or transceivers. It is also appreciated that the plurality of the receivers 102 or transponders 104 can be coupled together either by a cable or a plurality of cables e.g. to create a wired mesh of receivers or transponders, or coupled together wirelessly to create a wireless mesh of receivers or transponders. Still further it is appreciated that the system can comprise a mixture of plurality of transmitters and transceivers and/or a mixture of a plurality of receivers or transponders. It is appreciated that the mixture of the plurality of transmitters and transceivers and/or the mixture of a plurality of receivers or transponders can be coupled together either by one or more cables or wirelessly or a combination of one or more cables and wirelessly. Such embodiments can be configured to determine range and positioning to at least one object according to any of the signals and systems that have been described herein.

According to the disclosure above regarding any of the TOF ranging systems disclosed, it will be apparent that a TOF ranging system may be comprised of devices, any of which may transmit, receive, respond, or process signals associated with any of the foregoing TOF ranging systems. In aspects and embodiments, any transceiver, interrogator, transponder, or receiver may determine TOF information in one or more of the manners discussed above in accordance with any of the TOF ranging systems disclosed. Any transmitter, transceiver, interrogator, or transponder may be the source of a signal necessary for determining the TOF information in one or more of the manners discussed above in accordance with any of the TOF ranging systems disclosed.

It is appreciated that in embodiments, the exact position of signal generating and signal processing components may not be significant, but the position of an antenna is germane to precise ranging, namely the position and the location from which an electromagnetic signal is transmitted or received. Accordingly, the TOF ranging systems locations disclosed herein are typically configured to determine by the TOF ranging to antenna positions and locations. For example, the exemplary embodiments discussed above with respect to FIG. 2 and FIGS. 9 to 12 have multi-antenna components, and it is also appreciated that any of the embodiments of interrogators and transponders as disclosed in FIGS. 1-12 can have multiple antennas. In such example embodiments, and others like them, various components may be shared among more than one antenna and TOF ranging can be done to the multiple antenna components. For example, a single oscillator, modulator, combiner, correlator, amplifier, digitizer, or other component may provide functionality to more than one antenna. In such cases, each of the multiple antennas may be considered an individual TOF transmitter, receiver, interrogator, or transponder, to the extent that associated location information may be determined for such antenna.

In aspects and embodiments, multiple antennas may be provided in a single device to take advantage of spatial diversity. For example, an object with any of the TOF ranging components embedded may have multiple antennas to ensure that at least one antenna may be unobstructed at any given time, for example as the orientation of the object changes In one embodiment, a wristband may have multiple antennas spaced at intervals around a circumference to ensure that one antenna may always receive without being obstructed by a wearer's wrist.

In aspects and embodiments, signal or other processing, such as calculations, for example, to determine distances based on TOF information, and positions of TOF devices, may be performed on a TOF device or may be performed at other suitable locations or by other suitable devices, such as, but not limited to, a central processing unit or a remote or networked computing device.

### Other Examples

According to aspects and embodiments of any of the TOF ranging systems disclosed herein, the system can be used to accomplish precise distance measurements, to accomplish multiple distance measurements for multilateration, to accomplish highly precise absolute TOF measurements, to accomplish precision localization of a plurality of transponders, transceivers, or receivers, or to accomplish ranging with a hyperbolic time difference of arrival methodology, or any other ranging or localization capability for which TOF measurements may be used.

According to aspects and embodiments of any of the TOF ranging systems disclosed herein, the system can use any pulse compressed signal.

According to aspects and embodiments of any of the TOF ranging systems disclosed herein, each transponder can be configured to detect a signal of a unique code and respond only to that unique code.

According to aspects and embodiments of any of the TOF ranging systems disclosed herein, a plurality of transmitters or transceivers can be networked together and configured to transmit at regular, precisely timed intervals, and a plurality of transponders or receivers can be configured to receive the transmissions and localize themselves via a hyperbolic time difference of arrival methodology.

According to aspects and embodiments of any of the TOF ranging systems disclosed herein, at least one transceiver is carried on a vehicle.

According to aspects and embodiments of any of the TOF ranging systems disclosed herein, at least one transceiver may be fixed to a person or animal, or to clothing, or embedded in clothing, a watch, or wristband, or embedded in a cellular or smart phone or other personal electronic device, or a case for a cellular or smart phone or other personal electronic device.

According to aspects and embodiments of any of the TOF ranging systems disclosed herein, transceivers can discover each other and make an alert regarding the presence of other transceivers. Such discovery and/or alerts may be triggered by responses to interrogation signals or may be triggered by enabling transceivers via an auxiliary wireless signal as discussed. For example, vehicles could broadcast a BLE signal that activates any TOF transceiver in its path and thereby discover humans, animals, vehicles, or other objects in its path. Similarly, a human, animal, or vehicle in the path may be alerted to the approaching vehicle. In another scenario, people with transceivers on their person may be alerted to other people's presence, e.g., when joining a group or entering a room or otherwise coming in to proximity. In such a scenario, distance and location information may be provided to one or more of the people.

According to aspects and embodiments of any of the TOF ranging systems disclosed herein, the system can comprise a wireless network of wireless transponders in fixed locations, and wherein the element to be tracked includes at least one transceiver that pings the wireless transponders with coded pulses so that the transponders only respond and reply with precisely coded pulses.

According to aspects and embodiments of any of the TOF ranging systems disclosed herein, the system further comprises a wireless network of wireless transceivers or transponders in fixed locations that transmit or interrogate, and reply to each other, for purposes of measuring a baseline between the transceivers or transponders for calibrating the network.

According to aspects and embodiments of any of the TOF ranging systems disclosed herein, an object to be tracked includes at least one transceiver that is configured to transmit the first signal to interrogate one of a plurality of transponders in the network, and wherein at least one transponder is configured to respond to the first signal and to transmit a signal to interrogate one or more other transponders in the network, and wherein the one or more other transponders emit a second signal that is received by the original interrogator-transceiver for purposes of calibration.

According to aspects and embodiments of any of the TOF ranging systems disclosed herein, the system comprises at least one transponder that is programmed to send a burst of data and its timing transmission and including data for purposes of revealing any of temperature, battery life, other sensor data, and other characteristics of the transponder.

According to aspects and embodiments of any of the TOF ranging systems disclosed herein, the system can include wireless transponders configured to send ranging signals between each of the transponders for measuring distances between transponders.

### Motion Tracking

As discussed above, any transceiver, interrogator, transponder, or receiver may determine TOF information in one or more of the manners discussed above in accordance with any of the TOF ranging systems disclosed. Any transmitter, transceiver, interrogator, or transponder may be the source of a signal necessary for determining the TOF information in one or more of the manners discussed above. For simplicity in the discussion below, any such device, whether it transmits or receives, or both, may be referred to as a TOF device.

According to aspects and embodiments, a set of TOF devices may be used to track motion of an object. In one aspect, a set of TOF devices, such as a plurality of interrogators, is established at fixed locations and at least one TOF device, such as at least one transponder, may be attached to an object, or parts of an object, to be tracked. The terminology used herein shall be that TOF devices at fixed locations are fixed devices, while TOF devices whose locations are being determined (at multiple points in time) are tracked devices.

In one embodiment, three TOF devices may be established at fixed locations and the precise location of all other TOF devices may be determined by triangulation from the precise distance measurements made possible by any of the TOF ranging systems disclosed herein.

In another embodiment, four TOF devices may be fixed and precise location of tracked devices can be determined from multilateration or time difference of arrival methodologies. Further to the embodiment of four fixed devices, the location of the tracked devices may additionally or alternatively be determined by triangulation with respect to any three of the fixed devices. In yet other embodiments there may be more or fewer fixed TOF devices.

In another embodiment of the system, there could be three TOF devices established as the tracked devices disposed in a known XYZ pattern on the item or person being tracked and one or more low-profile, fixed devices in a room, on a device, etc. This arrangement is essentially the inversion of the system with 3-4 fixed devices and one or more moving devices on the person or item being tracked. With this arrangement, the system can estimate the position of the one or more fixed devices relative to the moving three or more moving devices. The Inverted arrangement solves the problem of estimating where a fixed point is relative to a moving object. Furthermore, to address possible occlusion problems to the one fixed device, one or more additional fixed devices could be provided in a work vicinity or area, in a room, on a support structure, on a display, on a console, over a geographic area to be surveyed, and the like, so as to provide redundant coverage to the object of interest (the tracked object) whenever the other fixed devices are occluded. Thus, according to aspects and embodiments, there can be at least 3 moving devices and any number of fixed devices.

### Subsurface Imaging Positioning System

In accordance with various aspects and/or embodiments of the subject disclosure, there is illustrated in FIG. 13 an example of a system and method for detecting a position of a subsurface imaging system, such as a ground penetrating radar (GPR) device or a seismic interrogation device. In this example embodiment a tripod 602 is outfitted with four fixed TOF devices 604. A GPR 606 is outfitted with at least one TOF device 608a-608c. The TOF devices 604 are fixed devices and the TOF devices 608a-608c are tracked devices. The tracked devices 608a-608c are affixed to the GPR 606 in chosen locations. Having multiple tracked devices 608 on the GPR 606 allows determination of the position and orientation of the GPR 606 and also provides for continued tracking of position of the GPR 606 when one or more of the tracked devices 608 may be occluded by obstructions, such as trees or other structures.

With the known fixed locations of the fixed devices 604, the precise location of any one or more tracked devices 608 may be determined at any point in time in accord with any of the TOF ranging systems disclosed above. Accordingly, the orientation and movements of the GPR 606 may be tracked and used to precisely orient the GPR data collected by the GPR 606 with the position data provided by the TOF system.

The GPR device 606 is a device or equipment, usually controlled by an operator 610, that generates ground penetrating radar waves 612 that propagate underground. When the propagating underground radar waves 614 interact with structural details under the ground, such as objects, material changes, cracks, and voids, the structural details cause reflections, or echoes, of the radar waves. The reflected waves 614 are received by the GPR device 606 and data is stored indicating the relative location under the surface and character of the reflected waves 614 to generate images of the subsurface.

The system and method includes employing a plurality of fixed TOF devices 604 on a support structure, such as a tripod 602, as has been described herein, that transmit and/or receive signals that detect movement of a tracked device (e.g., transponder) 608 mounted to the ground penetrating radar device 606, according to any of the embodiments or systems and with any of the signals that have been disclosed herein, for detecting movement and position of the GPR device 606 to ascertain the position of the GPR device 606. In particular, the system and method of FIG. 13 can be used to determine a high-precision measurement of the position and orientation of the GPR to centimeter and even millimeter accuracies. Ascertaining the position of the GPR device 606 and aligning the position data with data from the GPR device 606 will result in providing three-dimensional data of what is sensed below the ground to centimeter and millimeter position accuracies. According to aspects, the system and method can include at least one fixed device 604 mounted on at least one tripod 602 and according to embodiments can include three fixed devices 604 on a single tripod 602, four fixed devices 604 on a single tripod 602, or more. Alternatively, according to aspects, the system and method can include one or more fixed devices 604 on a plurality of tripods 704, such as two, three, four or more tripods. Such arrangements will allow for three or more signal to locate and determine a position and orientation of the GPR device 606. It is to be appreciated that with this arrangement, the architecture for determining the position of the ground penetrating radar (GPR) device 606 can be any of the herein disclosed architectures discussed with reference to FIGS. 1-12.

In particular, the system architecture can include a plurality of TOF fixed devices 604 as has been described herein that transmit and/or transmit and receive a signal for measuring movement of a tracked device (e.g., transponder) 608 mounted to the GPR device 606. According to aspects of this embodiment, a controller can be configured to receive measurements of movement of the receivers or tracked devices 608 as measured from the fixed devices 604, to track the position of the GPR device 606.

It is appreciated that the system and method as described herein can be used to determine a position of one or more tracked devices 608 mounted to the GPR device 606 in the case where a tracked device 608 mounted to the GPR device 606 is out of a line of sight with the fixed devices 604 on the one or more tripod 602. For example, in the case where the tracked device 608 mounted to the GPR device 606 is behind a tree or other obstacle and no longer in the line of sight of one or more fixed devices 604 on the one or more tripods 602, the system can be used to interpolate the position of the GPR device between line of sight measurements of the GPR device. For example, according to aspects, the line of sight measurements where the GPR device 606 is in the line of sight with the one or more fixed devices 604 can be used as boundary values for the measurements where the tracked device 608 mounted to the GPR device 606 is not in the line of sight with the one or more fixed devices 604 on the one or more tripods 602. Alternatively, according to aspects, the line of sight measurements where the GPR device 606 is in the line of sight with the one or more fixed devices 604 can be used to interpolate for the measurements where the tracked device 608 mounted to the GPR device 606 is not in the line of sight with the one or more fixed devices 604 on the one or more tripods 704. In various embodiments, when a tracked device 608 mounted to the GPR device 606 is not in the line of sight with the one or more fixed devices 604 on the one or more tripods 704, other fixed devices 608 may be in the line of sight with the one or more fixed devices 604 to provide precision location information.

In accordance with yet further aspects or embodiments, referring to FIG. 14, the system can include a controller 710 that receives measured data 712 from the GPR device 606 and position data 714 from the TOF ranging system, and can map and/or overlay or otherwise superposition the GPR measured data with the position data 714 to provide a 3D model or image data 716 of whatever is measured beneath the surface of the ground by a GPR device 606. It is appreciated that the GPR measured data 712 and the position data 710 can be stored on storage devices for the mapping and overlaying of the data for later processing of the data (off-line), can be determined at the time of the measurements or can be a hybrid of both. It is also appreciated that the combined 3D measured data can be displayed on a display.

In embodiments, the fixed devices 604 may be integrated to the tripod 602 or removably affixed to the tripod 602 or any other suitable support structure according to the operational requirements or application. In other embodiments there may be more or fewer fixed devices 604. For example, there may be only three fixed devices 604 arranged relative to the tripod 602 or other support structure. In some embodiments there may be more than one set of fixed devices 604. For example, there may be multiple tripods 602 placed at various locations in the vicinity of the ground survey work to accommodate more accurate positioning across a larger survey area or to allow signal coverage around structures or obstructions. It will be understood that any potential arrangement of fixed devices 604 may be acceptable, and may vary in accord with operational requirements or particular application. The resulting arrangement of multiple fixed devices 704, their relative fixed positions, may be manually programmed in to a central processing unit, but are preferably calibrated amongst themselves as discussed above. In particular, the fixed devices 704 are TOF devices and may be configured to determine the distances between themselves in order to configure their relative positions. Calibration of the fixed devices 604 may be by such automatic ranging and may be in combination with additional reference systems, such as GPS or geodetic survey data.

The physical arrangement of fixed TOF devices, such as, for example those in FIG. 13, may be implemented, in accordance with embodiments herein, as an antenna at each fixed TOF device location. One or more oscillators, mixers, amplifiers, digitizers, or other components, may be provided and each configured to serve one or more than one antenna at one or more locations. For example, FIGS. 10 and 12 each show examples of multiple antennas served by a single modulator and oscillator on the transmit side. FIGS. 2, 9, 11, and 12 each show examples of multiple antennas on a receive side, any of which could share an amplifier, mixer, digitizer, or FFT processor, for example, by a combiner/switch 24 as in FIG. 2 or multiplexing switch SW1 as in FIG. 11. Any suitable configuration of components is in accord with aspects and embodiments and may depend upon operational requirements, applications, and associated costs.

In order to facilitate communication between the various and disparately located component parts of any of the herein disclosed systems, a network topology or network infrastructure can be utilized. Typically the network topology and/or network infrastructure can include any viable communication and/or broadcast technology, for example, wired and/or wireless modalities and/or technologies can be utilized to effectuate the subject application. Moreover, the network topology and/or network infrastructure can include utilization of Personal Area Networks (PANs), Local Area Networks (LANs), Campus Area Networks (CANs), Metropolitan Area Networks (MANs), extranets, intranets, the Internet, Wide Area Networks (WANs)—both centralized and/or distributed—and/or any combination, permutation, and/or aggregation thereof.

It should be noted without limitation or loss of generality that while storage or persistence devices (e.g., memory, storage media, and the like) are not depicted, typical examples of these devices include computer readable media including, but not limited to, an ASIC (application specific integrated circuit), CD (compact disc), DVD (digital video disk), read only memory (ROM), random access memory (RAM), programmable ROM (PROM), floppy disk, hard disk, EEPROM (electrically erasable programmable read only memory), memory stick, and the like.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A system for tracking a ground imaging apparatus, comprising:
a plurality of fixed devices configured to transmit and/or receive signals used for time of flight (TOF) measurements, the plurality of fixed devices positioned at a plurality of fixed locations;
a first tracked device configured to transmit and/or receive signals used for TOF measurements, the first tracked device configured to be affixable to the ground imaging apparatus; and
a processor configured to determine one or more positions of the tracked device relative to one or more of the plurality of fixed devices based upon one or more TOF measurements between the tracked device and one or more of the plurality of fixed devices.

2. The system of claim 1 wherein the plurality of fixed devices comprises at least three fixed devices.

3. The system of claim 1 wherein the processor is configured to determine the one or more positions based upon absolute TOF distance measurements or based upon time difference of arrival (TDOA) measurements, or any combination thereof.

4. The system of claim 1 wherein the plurality of fixed devices are configured to be affixed to a portable structure.

5. The system of claim 1 wherein the processor is further configured to calibrate a position of one or more of the plurality of fixed devices relative to other of the plurality of fixed devices.

6. The system of claim 1 further comprising one or more additional tracked devices selectively affixable to the ground imaging apparatus, the processor further configured to determine one or more positions of the one or more additional tracked devices.

7. The system of claim 1 wherein the processor is further configured to determine a plurality of positions of each tracked device over a series of distinct moments in time.

8. The system of claim 1 further comprising a memory, the processor configured to store position and time information for one or more tracked devices in the memory.

9. The system of claim 1 wherein the processor is further configured to communicate position information for one or more tracked devices to a processor associated with the ground imaging apparatus.

10. The system of claim 1 wherein the processor is further configured to communicate position information for one or more tracked devices to a database.

11. The system of claim 1 wherein the processor is further configured to communicate position information for one or more tracked devices to a model of subsurface features.

12. The system of claim 1 wherein at least one of the signals is any one of a frequency modulated continuous wave (FMCW) signal, a direct sequence spread spectrum (DSSS) signal, a pulse compressed signal, a frequency hopping spread spectrum (FHSS) signal, a Doppler modulated signal, an amplitude modulated signal, a phase modulated signal, a coded modulated signal or any other modulated signal.

13. A method for determining and tracking motion of a ground imaging apparatus, comprising the steps of:
mounting at least one transponder to the ground imaging apparatus to be tracked, the transponder having a receiver which receives an electromagnetic signal and a transmitter that emits an emitted electromagnetic signal;
interrogating the at least one transponder by directing an interrogation electromagnetic signal at the transponder from at least three interrogators;
emitting at least three emitted electromagnetic signals from the transponder in response to the interrogation signal from the three interrogators; and
using the three emitted signals to determine a position of the transponder with respect to the at least three interrogators.

14. The method of claim 13, wherein the at least three emitted electromagnetic signals are used to accomplish position measurements by multilateration.

15. The method of claim 13, wherein the at least three emitted electromagnetic signals are used to accomplish position measurements by a hyperbolic time difference of arrival methodology.

16. The method of claim 13, wherein each emitted electromagnetic signal is a modulated version of the interrogation signal.

17. The method of claim 13, wherein each emitted electromagnetic signal is a frequency shifted version of the interrogation signal.

18. The method of claim 13, wherein the transponder is configured to emit the emitted signal only if the transponder has received an auxiliary signal, the auxiliary signal indicating the transponder is selected to transmit.

19. The method of claim 13, wherein the transponder is configured to emit the emitted signal only if the transponder receives the electromagnetic signal having one of a command protocol and a unique code in the electromagnetic signal to address the transponder.

20. The method of claim 13, further comprising transmitting signals between the at least three interrogators to measure a baseline between the interrogators for calibrating.

21. The method of claim 13, further comprising mounting multiple transponders to the ground imaging apparatus to monitor motion of the ground imaging apparatus.

22. The method of claim 21, further comprising determining a plurality of relative positions of the transponders at a plurality of times to monitor motion of the ground imaging apparatus over time.

23. The method of claim 13, further comprising at least one transponder including a sensor with the transponder configured to send a burst of data including data from the sensor for purposes of revealing characteristics of the ground imaging apparatus.

24. The method of claim 13, further comprising superpositioning the data of the position of the ground imaging apparatus with the ground imaging data.

25. The method of claim 24, further comprising forming one of a model and an image of a subsurface structure relative to the position data.
